(19) United States
(12) Patent Application Publication
(10) Pub. No.: US 2026/0315985 A1
(43) Pub. Date: Oct. 15, 2026

(54) METHOD FOR SEPARATING CO2 FROM THE ATMOSPHERE, AND SEPARATION DEVICE, IN PARTICULAR FOR CARRYING OUT THE METHOD

(71) Applicant: Siemens Energy Global GmbH & Co. KG, Munich (DE)

(72) Inventor: Ralph Joh, Seligenstadt (DE)

(73) Assignee: Siemens Energy Global GmbH & Co. KG, Munich (DE)

(21) Appl. No.: 19/484,474

(22) PCT Filed: May 2, 2024
(86) PCT No.: PCT/EP2024/062016

§ 371 Date: Nov. 14, 2025

(30) Foreign Application Priority Data
May 23, 2023 (DE) 10 2023 204 779.9

(51) Int. Cl. B01D 53/04; B01D 53/26

(52) U.S. Cl. CPC B01D 53/0438; B01D 53/0446; B01D 53/265; B01D 2257/504; B01D 2257/80; B01D 2259/4009

(57) ABSTRACT

A method for separating CO₂ from the atmosphere, in which an adsorption step and a desorption step following the adsorption step are carried out. In the adsorption step, air is applied to an adsorbent, wherein a portion of the CO₂ contained in the air is adsorbed by the adsorbent. In the desorption step, the adsorbent loaded with CO₂ is acted upon by a heating medium and heated, wherein adsorbed CO₂ is thermally expelled, and thereafter the adsorbent is acted upon by a cooling medium and prepared for a repeated adsorption step. A separation device for separating CO₂ from the atmosphere includes a desorption chamber through which a working medium flows and a DAC system includes such a separation device.

### CROSS REFERENCE TO RELATED APPLICATIONS

This application is the US National Stage of International Application No. PCT/EP2024/062016 filed 2 May 2024, and claims the benefit thereof, which is incorporated by reference herein in its entirety. The International Application claims the benefit of German Application No. DE 102023204779.9 filed 23 May 2023.

### FIELD OF INVENTION

The invention relates to a method for separating CO₂ from the atmosphere. The invention further relates to a separation device which is in particular formed to carry out the method.

### BACKGROUND OF INVENTION

Burning fossil fuels currently covers about 80% of the world's energy needs. In 2019, those burning and further industrial production processes emitted approximately 38,017 million tons of carbon dioxide (CO₂) into the atmosphere worldwide. In addition to fossil energy generation, at a share of 9.2% of total emissions, manufacturing and conversion of industrial raw materials made a considerable contribution to the continuous increase in CO₂ concentration in the atmosphere. The discussion regarding the negative impact of the greenhouse gas CO₂ on the climate has led to CO₂ recycling being contemplated. From a thermodynamic point of view, CO₂ is very low and can therefore only be re-reduced into useable products with difficulty.

An important application is capture of carbon dioxide (CO₂) from gas flows, e.g., from flue gases, exhaust gases, industrial exhaust gases, or atmospheric air. Capture of CO₂ directly from the atmosphere, which is known as direct air capture (DAC), is one of several means to mitigate anthropogenic greenhouse gas emissions, and being a non-fossil, location-independent CO₂ source, it offers attractive economic prospects for the commodities market and for the manufacture of synthetic fuels.

A particular approach for direct air capture is based on a cyclical adsorption and desorption process on, for example, solid, chemically functionalized sorption materials. Hence, for instance, WO 2016/005226 A1 and WO 2017/009241 A1 disclose methods based on cyclical adsorption and desorption using steam or a suitable amine-functionalized sorption material for extraction of carbon dioxide from atmospheric ambient air. Moreover, WO 2019/092127 A1 details a further class of sorption materials on the basis of potassium carbonate functionalization. This class of materials is also suitable for cyclical CO₂ adsorption and desorption processes.

The adsorption process normally takes place under atmospheric ambient conditions during which air flows through the sorbent material and a portion of the CO₂ contained in the air is chemically and/or physically bound or adsorbed to the surface or into the adsorbents. During the following CO₂ desorption, the adsorption material is normally heated, and the partial pressure of the carbon dioxide surrounding the sorbent can optionally be reduced by additionally applying a vacuum or exposing the sorbent to a purge gas flow and expelling it from the structure, e.g., by incorporating steam. In this context, the previously captured carbon dioxide is removed from the sorbent and can be recovered in a concentrated form.

One of the greatest challenges for energy and cost-efficient realization of direct air capture ensues from the low CO₂ concentration in the atmospheric air, which is nominally about 400 ppm from 2019, and the delivery of the correspondingly necessary large amounts of atmospheric air to a suitable gas separation structure as well as efficient cyclical process management of adsorption and desorption. In the course of the desired industrial application, the service life or long-term stability of the adsorbent material for the adsorption and desorption of atmospheric CO₂ for as high a number of cycles as possible is increasingly being considered in this context, also from an economic point of view.

### SUMMARY OF INVENTION

Against this background, it is an object of the invention to specify an improved method for separating CO₂ from the atmosphere which can achieve increased stability of the adsorbent. It is a further object of the invention to specify a separation device for separating CO₂ from the atmosphere equipped in a corresponding manner.

According to the invention, the object directed to a method is attained by means of a method for separating CO₂ from the atmosphere, in which an adsorption step and a two-stage desorption step following the adsorption step are carried out, wherein in the adsorption step air is applied to an adsorbent, wherein a portion of the CO₂ contained in the air is adsorbed by the adsorbent, and wherein in the desorption step the adsorbent loaded with CO₂ is acted upon by a heating medium and heated in a first desorption step, wherein adsorbed CO₂ is thermally expelled, and wherein thereafter in a second desorption step the adsorbent is acted upon by a cooling medium different from the heating medium and prepared for a repeated adsorption step.

In this context, the invention relies on the finding that DAC (direct air capture) is a new technology enabling removal of CO₂ from the atmosphere. However, the technology is currently still in an intensifying stage of development and industrialization. The most advanced technology in this respect is based on methods of selective absorption of CO₂ on specially developed adsorbents. Recovery and separation of pure CO₂ takes place in the following desorption process. In this context, the adsorbent is initially freed of ambient air in a closed system by means of evacuation. In a second step, the adsorbent is heated to about 100 °C, and CO₂ is desorbed under reduced pressure and can be suctioned out of a sorption apparatus. A considerable disadvantage of the previously known methods is that the adsorbent which is typically pretreated chemically with an amine-based component which is sensitive to oxygen at elevated temperatures, and hence rapid degradation of the adsorbent is reported when the adsorbent is once again exposed to the air flow for the next adsorption step without cooling after the desorption step.

The invention has recognized that efficient, effective, and controllable cooling is required in this respect which furthermore ensures avoiding or reducing harmful exposure of the adsorbent to oxygen. The proposed method of the invention is therefore particularly suitable for selective separation or capture of CO₂ from the ambient air under atmospheric pressure conditions, wherein the adsorbent is successively acted upon by two media in the desorption step. This type of treatment of the adsorbent advantageously leads to a preparation extending the life span and favors cyclical use of the adsorbent for adsorption of CO₂ in a DAC system multiple times. In this context, the proposed method management of desorption and treatment in at least two partial steps performed one after the other with a respective heating medium and a respective cooling medium achieves significantly longer stability and thus longer usability (service life) for the adsorbent, which is sensitive in particular to oxygenation.

In the desorption step, method management is carried out in two stages in a discharge phase with the heating medium and in a subsequent regeneration phase with the cooling medium. Using the heating medium, the CO₂ is already predominantly-but generally only almost completely-expelled from the adsorbent in the first desorption step and the adsorbent is heated to, for example, 100 °C. Having cooling medium subsequently act upon it in the second desorption step, in addition to the advantageous cooling effect for the sensitive adsorbent, effectuates a further advantage in the desorption step. In particular, in this context, even the residues of condensed heating medium still adhering to the surface of the adsorbent as a result of the first desorption step are efficiently and completely expelled from the structure by the cooling medium acting upon it. Disadvantageous, and therefore sometimes only incomplete, removal of the CO₂ from the adsorbent is improved by means of the two-stage performance of the desorption step to the extent that this type of preparation and surface processing also accomplishes increased capture rates (clogging) and purification of the adsorbent or more effective utilization of the available adsorbent surface. In this context, in addition to the cooling effect and the regeneration of the absorbent, purging with the cooling medium effectively also expels and eliminates any heating medium which has condensed on surface regions of the adsorbent. Consequently, not only is the CO₂ discharged from the adsorbent, but the adsorbent is also made ready and prepared for a next adsorption step. Flowing the cooling medium, for example, cooled nitrogen, through the adsorbent in the second desorption step leads to particularly uniform and extensive cooling of the adsorbent. In this context, a cooling medium different from the heating medium which is not water-saturated is employed. As a result of the cooling medium flow not being water-saturated, the water which has not been vaporized by previously being acted upon by the heating medium can advantageously also be removed completely from the desorption space and be reused.

In this context, the degradation of the adsorbent is reduced when compared to the known methods and a significantly higher number of cycles is achieved with almost the same storage efficiency. As a consequence, cyclical adsorption and desorption processes are possible in a large number of cycles, independently of the technical and constructional design and handling of a chamber receiving the adsorbent or a module. In this context, the method can advantageously be flexibly applied to different constructional embodiments of cyclical adsorption and desorption apparatuses and DAC container solutions from the prior art.

In a preferred embodiment of the method, in the desorption step the supply of heating medium is interrupted and switched to being acted upon by the cooling medium.

By switching from the heating medium to the cooling medium, the two partial steps in the desorption process are performed in a targeted manner as separate partial steps of the method. This is elicited by switching or changing over from the adsorbent being acted upon by the heating medium to the cooling medium. The change of media while purging the adsorbent leads to a division of the desorption step into independent partial steps. This method management leads to advantages in the degradation behavior of the adsorbent.

In this context, in a preferred design of the method, the adsorbent is acted upon by the cooling medium so that the adsorbent is cooled and dried.

As a consequence, in addition to cooling and corresponding inertization with respect to harmful exposure to oxygen at high temperatures, this also effectuates drying of the adsorbent by means of the cooling medium and can accomplish effective surface utilization for adsorption. Furthermore, the life span of the adsorbent is extended. It has been found that application of the cooling medium frees effective evaporation of residues of condensed heating medium on the surface of the adsorbent. This maintains the capacity of the adsorbent and regenerates it in each cycle almost without any loss. This can effectuate particularly advantageous and sustainable preparation of the adsorbent regarding technical and economic aspects in each cycle.

In a particularly preferred design of the method, the cooling medium is extracted from the adsorbent and cooled to a cooling temperature.

The cooling medium acts upon the adsorbent by purging the adsorbent, wherein the cooling medium is guided across the adsorbing surfaces of the adsorbent and through channel structures of the adsorbent and is extracted by suction. In this context, a pressure difference is set across the adsorbent from the input line on the inlet side to an output line on the outlet side as a suction pressure and is maintained for purification. For example, a pump or a compressor can be employed here on the outlet side and the coolant can be drawn in to carry out the purging procedure using the cooling medium. The cooling medium absorbs the heat of the adsorbent and heats up. After the purging procedure, the cooling medium is cooled to a cooling temperature of, for example, 10 °C-20 °C.

In this context, the cooling medium is preferentially guided in a cooling circuit, wherein the cooling circuit is supplied with fresh cooling medium as required.

Due to cyclical reuse and preparation, the cooling medium is advantageously almost not consumed. Nevertheless, it is expedient for a reservoir or an accumulator with cooling medium to be maintained so that, if necessary, any loss of cooling medium during repeatedly carrying out the method in a cyclical manner can be withdrawn and fed into the cooling circuit and the latter can be replenished. In this manner, the quality of the cooling medium is also ensured in the long term. In case of maintenance, a complete change and thus an exchange of the cooling medium can also be carried out.

In a particularly preferred embodiment of the method, a cooling medium different from the heating medium is used in the desorption step.

This favors the realization of the changeover process from the heating medium to the cooling medium and leads to higher efficiency of the purification of the adsorbent. As a consequence, in the partial steps, a respective adapted medium can be used as the heating medium and as the cooling medium. Furthermore, the adapted media selection of two media in the desorption step favors the cyclical mode of operation of the adsorption step and the multi-stage desorption step. It is also conceivable in principle to also carry out the additional cooling step in vacuo with “cold” water vapor as the cooling medium so that a cooling medium different from the heating medium is also provided thereby for carrying out the desorption step.

In a further preferred embodiment of the method, in the desorption step, before the adsorbent loaded with CO₂ is acted upon by the heating medium, the adsorbent is acted upon by a negative pressure, wherein the air surrounding the absorbent is pumped out.

As a consequence, the environment of the adsorbent loaded with CO₂ is initially advantageously freed of oxygen as fully as possible before actual desorption is started. Pumping out the ambient air of the adsorbent serves to prepare for actual desorption and prevents any exposure of the adsorbent to harmful oxygen during heating using the heating medium. In particular during this preparatory step, it is important and advantageous to avoid any oxidative degradation of the adsorbent. Simultaneously, high CO₂ purity of the CO₂ thermally expelled together with the heating medium is accomplished.

In the method, an inert purge gas, in particular pure nitrogen, is preferentially used as the cooling medium, wherein the inert purge gas is brought to the cooling temperature and supplied to the adsorbent.

Nitrogen is readily available as an inert gas and can be employed particularly advantageously for purging the adsorbent. The nitrogen can be provided in a nitrogen tank or in gas cylinders. Alternatively, the nitrogen can also be recovered from an air separation process “in situ” as required and used as the cooling medium for the method.

Preferably, water in the form of low-pressure steam is supplied to the adsorbent as the heating medium in the method.

The low-pressure steam can be withdrawn in a steam generator or withdrawn from a steam reservoir. In this manner, hot steam is made available as the heating medium which is used to expel the CO₂ from the loaded adsorbent.

Applying low-pressure steam as the heating medium and pure, cool nitrogen as the cooling medium in partial steps performed in two stages and separately in the desorption process results in numerous advantages when compared to the known solutions. In this manner, the DAC process can be carried out in a particularly advantageous and simple manner. The issue of oxidative adsorbent degradation, which has been known for some time in the prior art, can thereby be addressed very effectively and in a simple manner since the cooling efficiency is increased and exposure to oxygen at excessively high temperatures of the adsorbent is prevented.

For example, in the previously known approaches, a cooling step is provided in the desorption step. This cooling step makes use of the fact that direct introduction of low-pressure steam into the desorption space with the loaded adsorbent is utilized for heating up the adsorbent. This creates condensate which also precipitates on the surface of the adsorbent. By again severely lowering the pressure in the desorption space, vaporization of this condensate is effectuated, whereby the adsorbent is cooled. However, a disadvantage of this procedure is that, even in case of minor leaks, more ambient air flows into the desorption space and again delivers more harmful oxygen. However, this does not sufficiently prevent any degradation of the absorbent by oxygen.

In a particularly preferred embodiment of the method, water is condensed out of the CO₂ expelled using the low-pressure steam, wherein desorbed CO₂ is recovered in a concentrated form.

By means of phase separation of CO₂ dissolved in water, efficient further, particularly economical usage of water in a circuit is accomplished with a simultaneously high capture rate of pure and concentrated CO₂. By cooling, for example, the water from the low-pressure steam can be condensed out as the heating medium so that separation of the mixture of water and desorbed and at least partially dissolved CO₂ is achieved. In addition, the CO₂ can be further processed, in particular dried and stored or transported away. This method management has considerable advantages, in particular when compared to the known solutions. Therein, the amount of condensed water which can be vaporized as a condensate on the surface of the adsorbent, and thus the actual cooling capacity, is limited and cannot be influenced or controlled. The cooling capacity in these DAC systems depends solely on how much and at which location the condensate precipitates on the surface of the absorbent. These disadvantages are overcome by the cooling principle of the invention.

This is because the cooling principle of the invention with the two-stage desorption step enables vaporizing any condensate adhering to the adsorbent almost completely and hence to supply it, e.g., to economically interesting recycling. In contrast, with the known cooling principles, adsorbent wetted with residual condensate was dried in the following adsorption step only by the air flow of the ambient air. Ensuing therefrom, this technology results in considerable water consumption and is therefore very disadvantageous for application in regions low in water or is practically impossible to apply there. Using the invention, a DAC system can also be operated in areas low in water, which is precisely where inexpensive renewable energy in the form of solar energy is frequently available for system operation of a DAC system. Besides, in known methods, an evacuation step following the desorption is additionally proposed to thereby initiate vaporization of the condensate and to cool the adsorbent as much as possible before it is once again exposed to the ambient air. If the vaporization and cooling were to be carried out using air only, the adsorbent at 100 °C would come into contact with oxygen from the ambient air at a correspondingly high concentration, which would lead to rapid degradation of the adsorbent.

According to the invention, the object directed to a separation device is attained by means of a separation device for separating CO₂ from the atmosphere, comprising a desorption chamber through which a working medium can flow and in which an adsorbent can be introduced, wherein at the desorption chamber, an input line is connected to the inlet side and an output line is connected to the outlet side for the working medium, wherein a first changeover device is connected upstream of the input line and a second changeover device is connected downstream of the output line so that during a desorption operation, in a desorption step the absorbent can be changed over from being acted upon by a heating medium to the adsorbent being acted upon by a cooling medium as the working medium.

The separation device of the invention proposes an apparatus for a DAC system which is particularly equipped and suitable to carry out the method for separating CO₂ from the atmosphere according to the invention. This is enabled by an advantageous combination of a first changeover device and a second changeover device. In this context, a first changeover device is connected upstream of the desorption chamber and a second changeover device is connected downstream of the desorption chamber. As a consequence, for the desorption chamber with the adsorbent, depending on the changing state, a heating medium or a cooling medium can optionally act thereupon or flow therethrough. In this context, separate flow paths for the heating medium and the cooling medium open into those of the first changeover device on the inlet side. Correspondingly, separate flow paths for the heating medium and the cooling medium branch off from the second changeover device on the outlet side. In this manner, the separation device is designed such that the desorption step of an adsorbent loaded with CO₂ can be carried out in the desorption chamber in two stages or in two partial steps, wherein different working media can be supplied separately. As a consequence, efficient and almost complete desorption of CO₂ can be accomplished in operation, wherein the degradation of the absorbent due to exposure to oxygen is avoided by means of particularly effective cooling. Furthermore, the changeover devices make the separation device particularly advantageously configured and usable for cyclical operation.

In this context, the separation device can be used in a DAC system independently of the specific constructional design and handling of the adsorbent, e.g., an adsorbent module, and can be connected or integrated thereon. Hence, the separation device can be operated flexibly both in a DAC system with movable and with fixedly mounted absorbent modules with corresponding movable flaps for supply air. Only one input line and one output line are to be provided as a connection to the desorption chamber so that the respective working medium can optionally be supplied to the desorption chamber with the adsorbent.

In a preferred design of the separation device, at the first changeover device, a heating line for the heating medium and a cooling line for the cooling medium are connected to the inlet side.

As a consequence, separate supply connections for the working media are provided in the first changeover device so that the heating medium and the cooling medium can be supplied separately to the first changeover device on the inlet side, i.e., separately via a respective line. Simultaneously, the same input line and the same output line of the desorption chamber can each be utilized in a changing state when supplying one of the working media. Hereby, the separation device is embodied to be particularly cost-effective.

In a more preferred design of the separation device, at the second changeover device, a heating line is connected to the outlet side with a separator connected therein designed such that a mixture of heating medium and desorbed CO₂ can be extracted from the desorption chamber and the CO₂ can be separated from the heating medium.

Depending on the properties of the mixture, the separator can be functionally designed as a phase separator or as a material separator.

In this manner, when flowing or flushing through the adsorption chamber via the heating line in a heating operation, the mixture can be expelled from the desorption chamber and eliminated. Simultaneously, material or phase separation can be accomplished in the mixture by spatially separating the heating medium and the expelled CO₂. This enables recovery and further use of the separated CO₂ in a very pure form as well as reuse of the heating medium.

In a particularly preferred design of the separation device, at the second changeover device, a cooling line is connected to the outlet side with a separator connected therein designed such that a mixture having the cooling medium and heating medium can be extracted from the desorption chamber and the heating medium can be separated from the cooling medium.

Thereby, residues of condensed heating medium can advantageously also be expelled from the desorption chamber when the absorbent is acted upon by the cooling medium so that the condensate can be removed fully and particularly effective cooling can be effectuated by additional evaporative cooling of the absorbent. Besides, any residual amounts of CO₂ can be expelled using the cooling medium so that complete CO₂ discharge as well as very effective cooling of the adsorbent can be accomplished. This treatment in the desorption chamber again prepares the adsorbent at a high quality level for further loading, i.e., frees it of CO₂, and cools it. A plurality of cycles of adsorption and desorption with low degradation as a result of harmful exposure to oxygen is made possible by the separation device equipped in such a way.

Further, this design achieves that both a cooling line and a heating line advantageously lead away and branch off at the second changeover device, to which a changeover can be made. In this context, separate line paths are implemented on the outlet side of the changeover device and specifically different method-related treatment of the respective working medium is provided depending on the changing state of the changeover device. In this context, the heating medium and the cooling medium can be guided in a targeted manner via separate line paths having a respective separator designed in a way specific to the medium.

In a particularly preferred design of the separation device, the respective separator has a capture container in the cooling line and in the heating line so that phase separation of liquid phase and gaseous phase can be elicited.

In this context, a capture container can be designed as a condensate separator having a connection for the working medium on the inlet side. The heating line or the cooling line is connected to the connection on the inlet side. Phase separation occurs by gravity and the differences in density of the mixtures so that the liquid phase is obtained at the bottom and the gaseous phase is obtained at the top of the capture container and can be tapped off for further use. As a consequence, the capture container achieves that gaseous CO₂ desorbed in the heating line is separately partitioned off from the heating medium, for example, water. A cooler or condenser can be connected upstream in the heating line so that cooling of the phase mixture of heating medium and CO₂ is initially provided before the phase separation. Further, the capture container in the cooling line achieves that the cooling medium is separated and partitioned off from the heating medium, for example, from water. If an inert gas is applied as the cooling medium, for example, pure nitrogen, gas-liquid phase separation is likewise provided here in the condensate separator. If an inert gas is used, a gas cooler can additionally be connected upstream of the capture container in the cooling line so that cooling of the phase mixture of cooling medium, for example, nitrogen, and the heating medium is initially implemented before the phase separation. Residues of desorbed gaseous CO₂ can also be expelled via the cooling line so that a gas mixture of the gaseous inert cooling medium and fractions of CO₂ is obtained. In a cyclical mode of operation in a circuit of the cooling medium, the CO₂ content in the cooling medium will set itself to a constant low value corresponding to the partial pressure in a virtually steady-state manner.

In a particularly preferred design of the separation device, upon activation of the first changeover device and the second changeover device, a cooling circuit for the cooling medium is formed for the desorption chamber to be acted upon by the cooling medium as the working medium.

It is expedient and economically particularly advantageous to guide the cooling media flow in a closed cooling circuit upon its activation. Hence, when nitrogen is used as an inert gas and cooling medium, a closed nitrogen circuit can be provided. Refilling of cooling medium as required via a connection in the cooling circuit is advantageously provided.

In the separation device, the first changeover device and the second changeover device each have a controllable 3-way fitting.

By means of switchable and electrically controllable 3-way valves, the respectively desired line paths can be released for the heating medium and the cooling medium during a changeover procedure in an automated manner. Cyclical application of the adsorption step and a subsequent two-stage desorption step, with the heating medium acting upon the desorption chamber and the cooling medium subsequently acting thereupon, can thus be reliably carried out.

In this context, the separation device preferably has a steam container so that water in the form of low-pressure steam can be fed into the desorption chamber as the heating medium via the input line.

The low-pressure steam can be provided in the steam container itself by means of heating up water as required. Heating up can occur, for example, electrically by means of a heating rod. It is also possible to recover and provide low-pressure steam from solar thermal heating, for example, in connection of a DAC system with a CSP (concentrated solar power) system, and to stock it in the steam container or to couple it out of the solar thermal system in a metered manner if required.

The separation device is preferably provided with a gas container for an inert purge gas so that an inert purge gas is provided as the cooling medium which can be used to purge and cool the desorption chamber with the adsorbent.

Stocking the inert purge gas is an option, wherein a gas container for nitrogen is provided, for example. It is also possible to simply provide a package of gas cylinders or to maintain a container with liquid nitrogen from a coupled air separation system, from which gaseous nitrogen is recovered as an inert purge gas and withdrawn.

In a particularly preferred design, the separation device can be applied in a system for separating CO₂ from the atmosphere. Such a system can be embodied as a DAC system and has a separation device.

Further advantages, features and details of the invention will be apparent from the subsequent description of preferred exemplary embodiments as well as from the drawing. The features and combinations of features mentioned above in the description as well as the features and combinations of features mentioned in the following description of the figures and/or shown in the individual figures alone can be used not only in the respective indicated combination, but also in other combinations or individually without departing from the scope of the invention.

### BRIEF DESCRIPTION OF THE DRAWINGS

Exemplary embodiments of the invention are explained in detail with reference to a drawing. In the figures, in a schematic and highly simplified manner:

FIG. 1 shows a DAC system with a separation device according to the invention;

FIG. 2 shows a block diagram of a simplified method sequence for separating CO₂ from the atmosphere with a two-stage desorption step according to the invention.

### DETAILED DESCRIPTION OF INVENTION

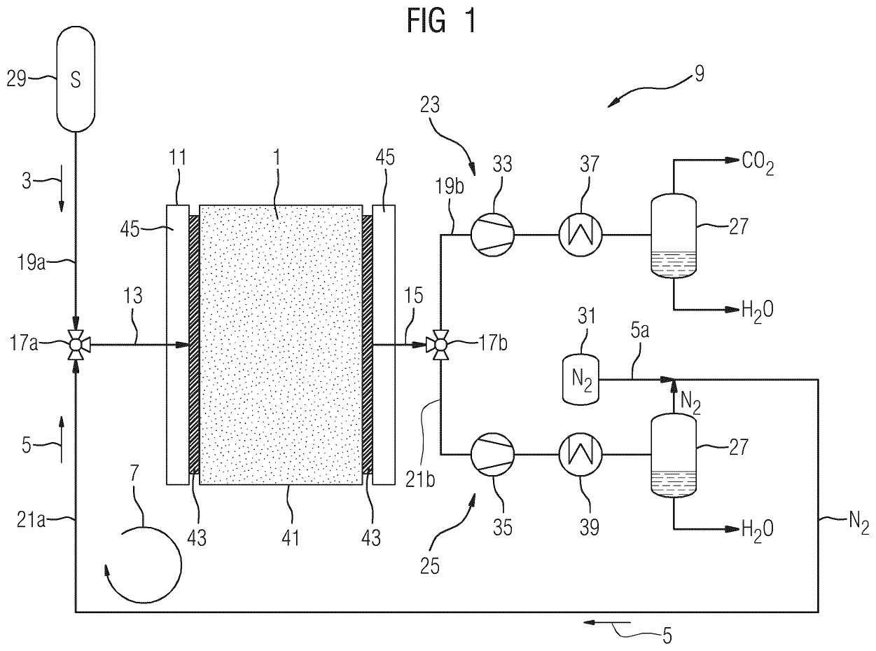

FIG. 1 shows a simplified depiction of a section of a direct air capture system, or “DAC system” for short, for selective capture of carbon dioxide CO₂ from the ambient air. For this purpose, the DAC system has a separation device 9. The separation device 9 comprises a desorption chamber 11 into which an adsorbent module 41 is introduced. The adsorbent module 41 has an adsorbent 1. The adsorbent 1 is a material which can selectively adsorb CO₂ from the ambient air. In this context, the adsorbent 1 can be introduced into the adsorbent module 41 as a fine-grained feed material or in another structure so that a largest possible effective adsorbent surface area is provided for adsorption or absorption of CO₂. Hence, it is also possible for the adsorbent 1 to be embodied in channel structures, honeycomb structures, or other porous structures. The desorption chamber 11 has closure elements 45 and a sealing system 43 so that an adsorbent 1 loaded with CO₂ can be performed in the desorption chamber 11 during the desorption process under conditions hermetically sealed off and separated from the ambient air.

At the desorption chamber 11, an input line 13 is connected to the inlet side and an output line 15 is connected to the outlet side for a respective working medium which can act upon the adsorbent 1. For this purpose, a respective working medium flows through the desorption chamber 11 with the adsorbent module 41. A first changeover device 17a is connected in the input line 13 and a second changeover device 17b is connected in the output line 15 so that a changeover operation, and thus different working media acting upon the adsorbent 1, becomes possible. This is achieved by having a heating line 19a connected to the first changeover device 17a at the inlet side, via which a heating medium 3 can be supplied to the desorption chamber 11. Further, a cooling line 21a is connected to the first changeover device 17a. A cooling medium 5 can be supplied to the desorption chamber 11 via the cooling line 21a as required. For separating the line paths and for further method-related and specific treatment of the heating medium 3 and the cooling medium 5, a corresponding heating line 19b and a cooling line 21b branch off at the second changeover device 17b on the outlet side. In this context, the heating line 19b is connected to a separator 23 and the cooling line is connected to a separator 25. The separator 23 on the heating line 19b has a vacuum pump 33, a cooler or condenser 37, as well as a capture container 27. The separator 25 on the cooling line 21b has a blower or compressor 35, with a gas cooler 39 and a capture container 27 connected thereto in the direction of flow of the cooling medium 5. The compressor 35 is connected in the cooling line 21b such that its suction side is connected to the outlet of the second changeover device 17b. The suction side of the vacuum pump 33 is connected into the heating line 19b and correspondingly connects to the second changeover device 17b. The first changeover device 17a and the second changeover device 17b each have a controllable 3-way fitting so that upon performance of a desorption process in the desorption chamber 11, a respective working medium acting upon the adsorbent 1 can be changed over in a targeted and selective manner.

In this context, a low-pressure steam S from a steam container 19 is provided as the heating medium 3 for a desorption operation. An inert gas, presently cooled gaseous nitrogen N₂, is provided as the cooling medium 5. The nitrogen N₂ can be stocked in a gas container 31 and can be withdrawn therefrom as required. As a consequence, nitrogen N₂ can be refilled as a fresh cooling medium 5a to compensate for any operational loss of cooling medium 5. When acted upon by the coolant 5, the coolant 5 is guided in a closed cooling circuit 7.

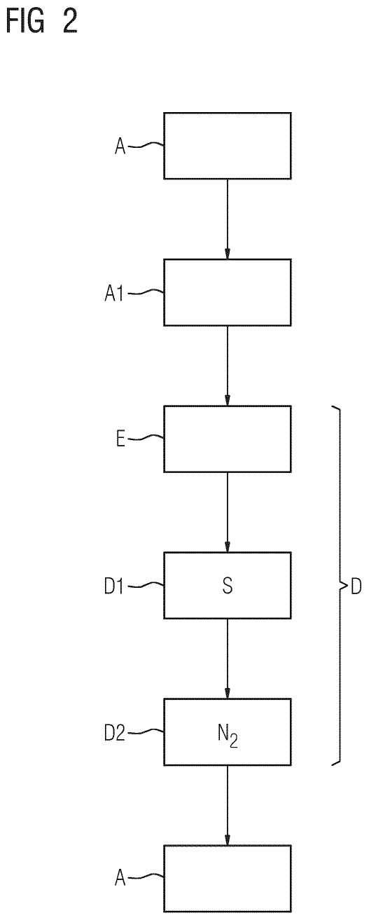

FIG. 2 illustrates the method for separating CO₂ from the atmosphere in a highly simplified manner in a schematic block diagram. In this context, an adsorption step A and a desorption step D following the adsorption step are carried out. In the adsorption step A, the adsorption chamber 11 is opened and ambient air which flows through the adsorption chamber 11 is applied to the discharged adsorbent 1. In this context, a portion of the CO₂ contained in the air is adsorbed by the adsorbent 1, incorporated into the surface-rich structure of the adsorbent 1, and an adsorbent 1 loaded with CO₂ is formed. After a saturation value has been reached and the adsorbent 1 has been sufficiently loaded with CO₂, the adsorption step A is terminated and the exposure to ambient air is discontinued. This occurs, for example, by closing the adsorption chamber 11 via movable closure elements 45 and sealing it in an air-tight manner via the sealing system 43. It is also possible for the adsorbent module 41 with the loaded absorbent 1 to be moved from an exposure position at the ambient air into a position in the desorption chamber 11 and for the desorption chamber 11 with the adsorbent module 41 to be subsequently sealed. This air-tight closure of the desorption chamber 11 is highlighted in FIG. 2 with a closing step A1, which can also be interpreted as a final step and partial step of the adsorption step A.

Desorption can now be carried out. In the desorption step D initiated for this purpose, the adsorbent 1 loaded with CO₂ is initially acted upon by the heating medium 3 and heated in a first desorption step D1. Low-pressure steam S is used as the heating medium 3 and supplied to the desorption chamber 11. In this context, adsorbed CO₂ is thermally expelled from the adsorbent 1. In a second desorption step D2, the adsorbent 1 is thereafter acted upon by the cooling medium 5 and prepared for a repeated adsorption step A. In this context, desorption occurs as a two-stage process, wherein pure and cooled nitrogen N₂ is used as the cooling medium 5. Initially, in the desorption step D1 the supply of heating medium 3 is interrupted and switched to being acted upon by the cooling medium 5—for example, nitrogen N₂. In this context, the cooling medium 5 acts upon the adsorbent 1 and flows therethrough extensively, wherein the adsorbent 1 is also cooled and dried from any residual clogging with condensed water H₂O from the first desorption step D1. The cooling efficiency is hereby significantly improved by means of additional leveraging of the evaporative cooling of the evaporating water H₂O. In this context, the cooling medium 5 is extracted from the adsorbent 1 and this is cooled to a cooling temperature. The cooling medium 5 is guided in a cooling circuit 7, wherein the cooling circuit 7 may be supplied with nitrogen N₂ as fresh cooling medium 5a only as required. The desorption step D is performed—as far as actual desorption of CO₂ is concerned—in two stages. Consequently, a heating medium 3 is used in the first desorption step D1 and a cooling medium 5 is used in the second desorption step D2, wherein the heating medium 3 and the cooling medium 3 are different media or fluids to achieve a particularly advantageous desorption by means of the combination of the first desorption step D1 and the second desorption step D2 and, above all, a significantly improved cooling effect in the second desorption step D2. Degradation of the adsorbent 1 can be prevented or at least significantly reduced by the comprehensive cooling and a low temperature. Exposure to oxygen at a lower working temperature in the adsorption step A is less harmful to the adsorbent 1 so that longer service lives are accomplished for the adsorbent 1 and thus a plurality of cycles of an adsorption step A and a desorption step D with the partial steps D1, D2 which are performed one after the other can be performed.

In the desorption step D, after the closing step A1, an evacuation step E is initially carried out. The evacuation step E serves to prepare the desorption chamber 11 with the loaded adsorbent 1 for the actual desorption process. In the evacuation step E, before the adsorbent 1 loaded with CO₂ is acted upon by the heating medium 3, the adsorbent 1 is initially acted upon by a negative pressure. In this context, the air surrounding the absorbent 1 in the desorption chamber 11 is pumped out. This occurs by activating the vacuum pump 33 for removal of the air. Thereafter, the desorption step D1 follows in which water H₂O in the form of low-pressure steam S, which correspondingly flows through the desorption chamber 11, is supplied to the adsorbent 1 as the heating medium 3. The water H₂O from the mixture of low-pressure steam S and expelled CO₂ is condensed out in the capture container 27 and desorbed CO₂ in a concentrated form is recovered at the top of the capture container 27 and captured. After the changeover, the second desorption step D2 follows, in which the inert purge gas, in particular pure nitrogen N₂, is used as the cooling medium 5. The nitrogen N₂ is brought to a specified cooling temperature in the gas cooler 39 and supplied to the adsorbent 1 via the cooling line 21a via the first changeover device 17a, wherein the adsorbent 1 is flown through, cooled, and prepared for a further adsorption step A. Via the output line 15, the nitrogen N₂ is guided through the second changeover device 17b to the separator 25 via the cooling line 21b. This realizes a cooling circuit 7.

The invention proposes a two-stage desorption process. By means of an inexpensive external cooling medium 5 in the second desorption step D2, the cooling of the adsorbent 1 becomes significantly more efficient, more effective and, furthermore, more controllable and reproducible. For this purpose, a distinct cooling medium 5 is introduced into the desorption chamber 11 for the cooling step in the second desorption step D2. Here, nitrogen N₂, e.g., is particularly advantageous being a gaseous inert heat carrier. To minimize the consumption of nitrogen, the heated nitrogen N₂ is cooled again in a gas cooler 39 and can be recycled many times. The flushing and purging of the desorption chamber 11 with pure nitrogen N₂ in the second desorption step D2 effectuates that even CO₂ not completely desorbed by the loaded adsorbent 1 previously in the first desorption step D1 is now additionally desorbed and expelled from the desorption chamber 11 together with the inert purging medium nitrogen N₂. However, this is not an issue insofar as the CO₂ content will only level up to a partial pressure, which leads to the desorption of residual CO₂ from the absorbent 1 no longer experiencing any driving force. After the described leveling up and CO₂ saturation, the cooling medium 5 can therefore be guided in a cooling circuit 7 at a constantly low CO₂ concentration. At the same time, by being acted upon by nitrogen N₂ as the cooling medium 5, the condensate of water H₂O remaining on the adsorbent 1 is also evaporated in a targeted manner and will hence additionally contribute to the cooling effect by evaporative cooling. Since the temperature of the nitrogen N₂ can be regulated for this type of cooling and the duration of the desorption step D2 with the cooling step can also be freely selected, a desired target temperature of the adsorbent for operation in the adsorption step A and also the degree of drying of the adsorbent can be controlled. In the gas cooler 39, the water H₂O evaporated by evaporative cooling is initially separated again as a condensate, i.e., liquid water H₂O, and can hence advantageously be reused. The water H₂O is not emitted and consumed with the treated media flow.

The cooling process in the second desorption step D2 is carried out at a slight positive pressure with respect to the atmospheric pressure of the environment. As a consequence, there is no risk of oxygen flowing from the ambient air into the interior of the desorption chamber 11. If the adsorbent module 41 remains filled with nitrogen N₂ at the end of the cooling step, this gas quantity of nitrogen N₂ is output to the atmosphere when ambient air is once again applied and loaded to the adsorbent module 41. It is therefore advantageous and expedient to feed at least this gas quantity of nitrogen N₂ into the cooling circuit 7, for example, by withdrawing it from the gas container 31. This can occur, e.g., by restoring a selected working pressure as the target pressure in the cooling circuit 7 by feeding nitrogen N₂ from the gas container 31 into the cooling circuit 7 in a correspondingly regulated manner. By continuously supplying an inert purge gas, e.g., nitrogen N₂, the cooling can be regulated and controlled in accordance with the requirements. Thereby, cooling to a necessary surface temperature of the adsorbent 1 can be reliably set and this surface temperature can be ensured. The cooling medium 5 provided as a cooling gas can be directed through the adsorbent 1 via gas distributors—not depicted in more detail in FIG. 1—in a very uniformly distributed manner, whereby very disadvantageous temperature gradients or unequal temperature distributions are avoided. This is very advantageous when compared to cooling by flash vaporization in vacuo according to the previously known concepts. This is because in the known flash vaporization, it depends on where and in what amount condensate has precipitated. Depending on the geometry of the adsorbent module 41, the precipitate of the condensate will not be uniformly distributed over the surface of the adsorbent 1. That is, with the aid of flash vaporization, energy is locally removed from the adsorbent material by evaporation only where water H₂O is present. Regions in the adsorbent module 41 at which more water H₂O precipitates than is required for cooling cannot make any further contribution to cooling, since no further energy flow can occur due to the prevailing temperatures.

The essential economic advantage ensues from decreased degradation of the adsorbent 1 due to exposure to oxygen. Due to the degradation, the adsorbent loses storage capacity for binding CO₂ so that this has to be either replaced or regenerated at great expense. Besides, an extension of the lifetime of the adsorbent 1 by means of the cooling concept of the invention and the separation device 9 proposed for this purpose and the advantageous method management for the desorption step D decreases the amount of maintenance required and increases system availability of a DAC system.

1. A method for separating CO₂ from the atmosphere, comprising:
carrying out an adsorption step and a two-stage desorption step following the adsorption step,
wherein in the adsorption step, air is applied to an adsorbent, wherein a portion of the CO₂ contained in the air is adsorbed by the adsorbent, and
wherein in the desorption step, the adsorbent loaded with CO₂ is acted upon by a heating medium and heated in a first desorption step, wherein adsorbed CO₂ is thermally expelled, and wherein thereafter in a second desorption step the adsorbent is acted upon by a cooling medium different from the heating medium and prepared for a repeated adsorption step.

2. The method of claim 1,
wherein in the desorption step a supply of heating medium is interrupted and switched to being acted upon by the cooling medium.

3. The method of claim 2,
wherein the adsorbent is acted upon by the cooling medium so that the adsorbent is cooled and dried.

4. The method of claim 1,
wherein the cooling medium is extracted from the adsorbent and cooled to a cooling temperature.

5. The method of claim 1,
wherein the cooling medium is guided in a cooling circuit, wherein the cooling circuit is supplied with fresh cooling medium as required.

6. The method of claim 1,
wherein a cooling medium different from the heating medium is used in the desorption step.

7. The method of claim 1,
wherein in the desorption step, before the adsorbent loaded with CO₂ is acted upon by the heating medium, the adsorbent is acted upon by a negative pressure, wherein the air surrounding the adsorbent is pumped out.

8. The method of claim 1,
wherein an inert purge gas, in particular pure nitrogen (N₂), is used as the cooling medium, wherein the inert purge gas is brought to a cooling temperature and supplied to the adsorbent.

9. The method of claim 1,
wherein water (H₂O) in the form of low-pressure steam is supplied to the adsorbent as the heating medium.

10. The method of claim 9,
wherein water (H₂O) is condensed out of the CO₂ expelled using the low-pressure steam, and desorbed CO₂ is recovered in a concentrated form.

11. A separation device for separating CO₂ from the atmosphere, comprising:
a desorption chamber through which a working medium is flowable and in which an adsorbent is introducible, wherein at the desorption chamber, an input line is connected to an inlet side and an output line is connected to an outlet side for the working medium,
wherein a first changeover device is connected upstream of the input line and a second changeover device is connected downstream of the output line so that during a desorption operation, in a desorption step the adsorbent is changed over from being acted upon by a heating medium to the adsorbent being acted upon by a cooling medium as the working medium.

12. The separation device of claim 11,
wherein at the first changeover device, a heating line for the heating medium and a cooling line for the cooling medium are connected to the inlet side.

13. The separation device of claim 11,
wherein at the second changeover device, a heating line is connected to the outlet side with a separator connected therein designed such that a mixture of heating medium and desorbed CO₂ is extractable from the desorption chamber and the CO₂ is separable from the heating medium.

14. The separation device of claim 11,
wherein at the second changeover device, a cooling line is connected to the outlet side with a separator connected therein designed such that a mixture having cooling medium and heating medium is extractable from the desorption chamber and the heating medium is separable from the cooling medium.

15. The separation device of claim 13,
wherein the respective separator has a capture container in the cooling line and in the heating line so that phase separation of liquid phase and gaseous phase is elicitable.

16. The separation device of claim 11,
wherein upon activation of the first changeover device and the second changeover device, a cooling circuit for the cooling medium is formed for the desorption chamber to be acted upon by the cooling medium as the working medium.

17. The separation device of claim 11,
wherein the first changeover device and the second changeover device each have a controllable 3-way fitting.

18. The separation device of claim 11,
wherein a steam container is provided so that water (H₂O) in the form of low-pressure steam is fed into the desorption chamber as the heating medium via the input line.

19. The separation device of claim 11,
wherein a gas container for an inert purge gas is provided so that an inert purge gas is provided as the cooling medium which is useable to purge and cool the desorption chamber with the adsorbent.

20. A system for separating CO₂ from the atmosphere, comprising:
a separation device of claim 11.
